(19) United States
(12) Patent Application Publication
(10) Pub. No.: US 2012/0195803 A1
(43) Pub. Date: Aug. 2, 2012

(54) HIGH ENERGY POWER PLANT FUEL, AND CO OF CO2 SEQUESTERING PROCESS

(76) Inventor: James Charles Juranitch, Ft. Lauderdale, FL (US)

(21) Appl. No.: 13/382,156

(22) PCT Filed: Jul. 2, 2010
(86) PCT No.: PCT/US10/01931

§ 371 Date: Apr. 16, 2012

Related U.S. Application Data
(60) Provisional application No. 61/270,035, filed on Jul. 3, 2009.
(60) Provisional application No. 61/281,674, filed on Nov. 19, 2009.

(30) Foreign Application Priority Data
Jul. 1, 2009 (US) PCT/US09/03934

(51) Int. Cl. B01J 19/08

(52) U.S. Cl. 422/186

(57) ABSTRACT

A system for increasing the conversion efficiency in a Fischer Tropsch based reactor system operating at low pressure for treating reactants or an exhaust stream generated by industrial processes. CO or CO₂ are sequestered and the gas is converted into a useful fuel. A plasma converter is used to generate the primary reactant which is hydrogen.

### RELATIONSHIP TO OTHER APPLICATIONS

This application claims the benefit of the filing date of U.S. Provisional Patent Application Ser. No. 61/281,674, filed Nov. 19, 2009 (Foreign Filing License Granted) and U.S. Provisional Patent Application Ser. No. 61/270,035, filed Jul. 3, 2009, Confirmation No. 9380 (Foreign Filing License Granted); and is a continuation-in-part of copending International Patent Application Ser. No PCT/US2009/003934, filed Jul. 1, 2009, which claims the benefit of the filing date of U.S. Provisional Patent Application Ser. No. 61/133,596, filed Jul. 1, 2008; and which claims the benefit of the filing dates of, U.S. Provisional Patent Application Ser. Nos. 61/199,837, filed Nov. 19, 2008; 61/199,761 filed Nov. 19, 2008; 61/201,464, filed Dec. 10, 2008; 61/199,760, filed Nov. 19, 2008; 61/199,828 filed Nov. 19, 2008, 61/208,483, filed Feb. 24, 2009; 61/270,928, filed Jul. 14, 2009; 61/270,820, filed Jul. 13, 2009; 61/215,959, filed May 11, 2009; and 61/208,483 filed Feb. 24, 2009, the disclosures of all of which are incorporated herein by reference.

### BACKGROUND OF THE INVENTION

1. Field of the Invention

This invention relates generally to a system for enhancing the conversion rate in a reactor such as a Fischer Tropsch, or methanol reactor while operating at a low pressure. This is key in applications that are looking to minimize capital facility investment, and energy consumption in applications of dilute reactants where large flow rates exist such as in the processing of CO₂ in an exhaust stream of a power plant.

2. Description of the Related Art

In the past the chemical industry has used higher concentrations of reactant than stoichiometric to aid in conversion efficiency of processes that utilize inexpensive reactants such as steam reformation. This has not been the case in a processes that uses hydrogen as a primary reactant. Hydrogen is expensive and difficult to produce. It is also dangerous when liberated as an excessive reactant at the conclusion of a process. With the advent of a plasma converter to generate hydrogen, high flow rate reactors such as foam reactors, and finally the introduction of functional membranes that can reliably reclaim hydrogen the combination of these components have now been brought together in this invention in a novel way.

### SUMMARY OF THE INVENTION

In the parent patent applications listed above the systems therein described function in part to produce a fuel or product from a Fischer Tropsch style reactor, and in some cases in a methanol reactor. In all of the patent applications their primary hydrogen generators (reactant) are a plasma chamber. This is an efficient hydrogen generator. Conversely this invention works for any hydrogen generator such as hydrolysis or fluid bed style generators. To date when reactants such as hydrogen and CO₂ have been processed in a reactor they have been required to be operated at high pressures. In some examples up to many hundreds of atmospheres to enjoy high conversion efficiencies. This is energy inefficient and capital intensive when implemented in a high flow environment with dilute reactants. The patent applications noted above operate in this condition while sequestering CO₂ from a power plant or other manufacturing plant's exhaust, or processing any CO or CO₂ stream of reactants. Compressing this mammoth flow to high pressure causes huge energy penalties. Here to for that has made the process of sequestering CO₂ from a manufacturing process raw exhaust flow not feasible. This invention teaches a way to enjoy high conversion efficiency without the continuing energy penalty associated with a high pressure operation.

### BRIEF DESCRIPTION OF THE DRAWING

Comprehension of the invention is facilitated by reading the following detailed description, in conjunction with the annexed drawing, in which:

FIG. 1 is a simplified schematic representation of the invention.

### DETAILED DESCRIPTION

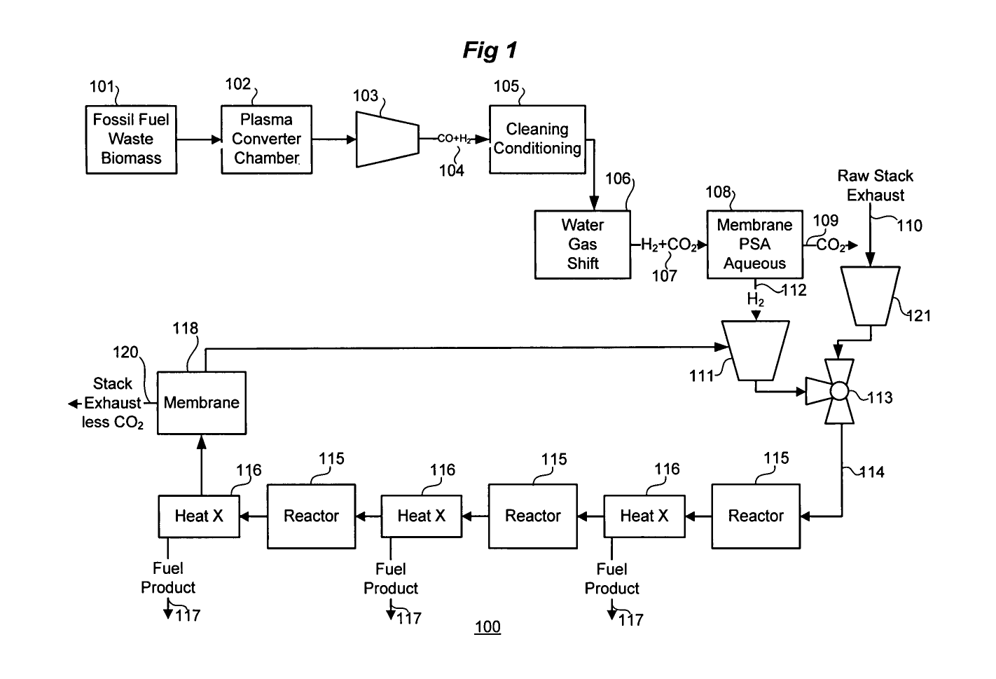

FIG. 1 is a simplified schematic representation of a system 100 having a source of any combination of fossil fuel, waste, and or biomass 101 that represents the feedstock for the production of a reactant hydrogen, as will be described below. A plasma Chamber 102 is employed in this embodiment of this invention for the creation of hydrogen. It is to be understood that this invention is not limited to only hydrogen as a reactant or plasma in general. Other reactants and hydrogen generators such as fluidized beds, or hydrolysis processes can also be used.

A compressor 103 issues at its output 104 dirty H₂ and CO (Syngas) produced by the plasma chamber, which then is conditioned and cleaned in a cleaning and conditioning system 105. A water gas shift reactor 106 is optional, and its use is dependent upon the reactor and process being implemented.

An output gas 107, which consists primarily of H₂ and CO₂ at this point, is directed into a system for concentrating the H₂ reactant such as a PSA, Membrane, or Aqueous Solution, designated herein as 108. The concentrated H₂ is delivered to a compressor 111, which in the case of a methanol system only has to boost the process pressure to approximately 20 atmospheres to reach a high conversion efficiency. This is approximately 5 times less pressure than many competing processes require. Low pressure hydrogen is combined with similar low pressure raw exhaust stack gas 110 is boosted in compressor 121 and combined in a combiner valve 113 with pressure boosted H₂ at the output of compressor 111. Compressor 121 and CO₂ stream 110 are optional in the practice of the invention.

In some embodiments of the invention, CO or CO₂ can be generated and recycled directly from output gas stream 107. An inner loop of a high concentration of H₂ is established by control valve 113 and a membrane separator 118. The control valve and the membrane separator serve to recycle the unused excess H₂ in reactors 115. This present invention charges the reactant loop, which in this embodiment is a H₂ concentration, to over 5 times the typical stoichiometric amounts required. This highly saturated level of reactant allows reactors 115 to work at high efficiencies for their low pressure. Reactors 115 in the various embodiments of the invention are pellet style reactors, foam style reactors, or alpha alumina oxide foam reactors. The foam reactors facilitate high flow performance with exceptional heat transfer characteristics.

The output of each reactor heat exchanger system 116 condenses the yielded product 117 to enhance the performance of each subsequent reactor that is positioned further downstream in the series of reactors 115 shown in the figure.

The number of reactors 115 and heat exchanger systems 116 that are used in the practice of the invention are determined primarily by a financial optimization of reactor capital cost and conversion efficiency, versus compressor capital cost, versus energy costs associated with a high pressure operation.

After the final reactor stage and the membrane separator 118 in this embodiment, Raw Stack Exhaust gas exits as a product at output 120 of membrane 118 with a significantly reduced CO₂ concentration. The CO₂ has been consumed as an additional reactant and has been expelled in liquid product fuel 117 in this embodiment.

Although the invention has been described in terms of specific embodiments and applications, persons skilled in the art can, in light of this teaching, generate additional embodiments without exceeding the scope or departing from the spirit of the invention herein claimed. Accordingly, it is to be understood that the drawing and description in this disclosure are proffered to facilitate comprehension of the invention, and should not be construed to limit the scope thereof.

What is claimed is:

1. A system for treating a reactant or an exhaust stream issued by a manufacturing process, the system comprising the step of processing the exhaust stream in a Fisher Tropsch reactor, with an H₂ ratio many times stoichiometric which is generated by a plasma converter, the excess hydrogen being reclaimed and recirculated through the process.

2. The system of claim 1, wherein the reactant stream contains CO.

3. The system of claim 1, wherein the reactant stream contains CO₂.

4. The system of claim 1, wherein the reactant stream is a full stack exhaust stream.

5. The system of claim 1, wherein the Fischer Tropsch reactor is a pellet style of reactor.

6. The system of claim 1, wherein the Fischer Tropsch reactor is a foam reactor.

7. The system of claim 1, wherein the Fischer Tropsch reactor is an alpha alumina oxide foam reactor.

11. The system of claim 1, wherein the hydrogen is reclaimed by a membrane.

12. The system of claim 1, wherein the hydrogen is reclaimed by a PSA.

13. The system of claim 1, where the hydrogen is reclaimed by an Aqueous Solution.

14. The system of claim 1, wherein the Fischer Tropsch reactor is a methanol reactor.
